(19) United States
(12) Patent Application Publication
(10) Pub. No.: US 2026/0131458 A1
(43) Pub. Date: May 14, 2026

(54) A Responsive Teach Interface for Programming an Industrial Robot

(71) Applicant: ABB Schweiz AG, Baden (CH)

(72) Inventors: Andreas Skaar, Bryne (NO); Morten Mossige, Nærbø (NO)

(21) Appl. No.: 18/697,612

(22) PCT Filed: Oct. 11, 2021
(86) PCT No.: PCT/EP2021/078046

§ 371 Date: Apr. 1, 2024

(51) Int. Cl. B25J 9/16

(52) U.S. Cl. CPC B25J 9/163

(57) ABSTRACT

A method of generating a program for controlling an industrial robot, including: receiving a tentative control point to be executed by a manipulator of the industrial robot, wherein the tentative control point is entered using a handheld or body-worn input device with a motion tracking capability; generating a tentative path segment connecting the tentative control point with a preceding control point; evaluating the tentative path segment's feasibility using a predefined computer model of the manipulator, and providing feedback indicating an outcome of the evaluation.

### TECHNICAL FIELD

The present disclosure generally relates to the field of robotic control. In particular, it describes a teach interface which an operator can use to input control points into a robot program for controlling an industrial robot. The teach interface is configured to provide the operator with feedback as to whether the control points define path segments that are suitable for execution by the robot.

### BACKGROUND

The state of the art includes a variety of robot teach interfaces which provide immediate haptic collision feedback if the operator is attempting to configure robot movements that would collide with obstacles. Examples include US20160318185A1, which discloses a control device adapted to let the operator instruct movements of a robot arm provided with a tool for holding an object. This way, using the control device, the operator manually controls the movements of the object. The control device transmits forces and torque experienced by the object, such as when the object hits an obstacle. US20190358817A1, for its part, discloses a system where a slave robot arm is programmed to follow the movements of a master robot arm manually displaced by the operator. The master robot arm is configured for bidirectional transfer of force and torque between the master robot arm and the slave robot arm, such that haptic feedback is complied with. Finally, US20090012532A1 discloses a surgical robot system, in which any collisions between a virtual representation of a tool and virtual objects in a virtual environment are detected. If a collision occurs, the system calculates haptic reaction force and delivers it to the operator's hand.

The robot movement verification offered by this type of teach interfaces can be described as pointwise and time-continuous. It does not support such robot programming paradigms where new robot paths are defined by discretely entered control points. Teach interfaces of this type may as well be unable to discover and communicate other error states than collisions.

### SUMMARY

One objective of the present disclosure is to make available a teach interface that enables interactive robot teaching in terms of control points entered by a handheld or body-worn input device. Another object is to propose such a teach interface that provides the operator with feedback as to whether a tentative path segment defined by said control points is feasible with respect to collisions, singularities, reachability or combinations of these. It is desirable for the teach interface to evaluate the tentative path segment—or multiple tentative path segments—by means of a model-based, stateful process that considers a past trajectory of the robot manipulator. A further object of the present disclosure is to make available a method with these characteristics for generating a robot program.

At least some of these objectives are achieved by the present invention as defined by the independent claims. The dependent claims relate to embodiments of the invention.

In a first aspect, there is provided a method of generating a program for controlling an industrial robot. The method comprises: receiving a tentative control point to be executed by a manipulator of the industrial robot, wherein the tentative control point is entered using a handheld or body-worn input device with a motion tracking capability; generating a tentative path segment connecting the tentative control point with a preceding control point; evaluating the tentative path segment's feasibility using a predefined computer model of the manipulator; and providing feedback indicating an outcome of the evaluation.

As used in this disclosure, “control points” in a robot program are points in space which the robot manipulator is instructed to visit in a particular order and, optionally, at specified points in time. A control point may optionally include an orientation of a tool carried by the manipulator. The position of the manipulator may be defined as the position of a reference point on the manipulator, such as a tool center point (TCP). One point in (Cartesian) space can correspond to more than one point in a joint space of the manipulator, which describe those poses for which the manipulator position equals the point. A “path segment” is a curve in space followed by the manipulator position which connects two control points. Similarly, a path segment may have multiple joint-space realizations. A “motion tracking capability”, finally, refers to the input device's ability to determine its own position or to allow its position to be determined by another component.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order described, unless explicitly stated.

A difference between the first aspect of the invention and the background art initially reviewed is that the feasibility evaluation is directed to the path segment that connects the tentative control points. This is different from recording a trajectory of the input device and incorporating it into the program. Embodiments of the invention may support programming done in terms of control points rather than paths, where the path is instead generated in an automated fashion, in view of not only feasibility (collisions, singularities, reachability etc.) but also performance and cost, which may lead to better-performing robot programs. Thanks to the ability to repeat the automated path generation multiple times and/or to rule out unpromising tentative paths at an early stage, a teach interface executing this method may be led to provide negative feasibility feedback relatively seldom. Accordingly, operators may perceive the teach interface as more supportive and helpful.

In some embodiments, different feedback is given depending on the reason why the feasibility evaluation failed. This helps the operator distinguish between collision, singularity and non-reachability, so that his next tentative control point can be chosen accordingly. The differentiated feedback may also help shorten the operator's learning curve, to reduce the time he needs to be become acquainted with the characteristics of a new industrial robot.

In some embodiments, multiple tentative path segments are generated for one new tentative control point. This way, the feasibility evaluation can immediately evaluate a number of candidate solutions to the problem of connecting the tentative control point and the preceding control point, thereby reducing the incidence of negative outcomes of the feasibility evaluation as a whole. In a further development of these embodiments, the feasibility evaluation includes evaluating alternative joint-space realizations of (at least one of) the tentative path segment(s). This may help avoid a singularity that affects some though not all joint-space realizations. None of these advantages are possible with a prior art teach interface where the tentative path is explicitly defined by the operator, indeed, since the robot manipulator is obligated to follow that path and has no leeway either to optimize its position (e.g., deviate from a straight connecting line) or to try different realizations in joint space.

In some embodiments, the feasibility evaluation is implemented as a stateful (or memoryful) process, which depends on a past trajectory of the manipulator. For example, if the preceding control point has been attained from a specific direction of motion and/or in such manner that the manipulator ends up with a specific set of joint angles, then this information is applied as a constraint when generating the tentative path segment. The constraint may be a boundary value or an initial value. The constraint may ensure that the movement past a control point is smooth, feasible and does not lead to excessive mechanical wear. Accordingly, these embodiments may help eliminate weaknesses of robot paths which could not be discovered with the prior art teach interfaces.

In a second aspect of the present invention, there is provided a teach interface for generating a program for controlling an industrial robot. The teach interface comprises: a processing unit with access to a computer model of a manipulator of the industrial robot; an input device suitable for being held or worn by an operator; and an output device configured to provide feedback to the operator. According to the second aspect, the processing unit further comprises processing circuitry configured to: receive from the input device a tentative control point to be executed by the manipulator of the industrial robot; generate a tentative path segment connecting the tentative control point with a preceding control point; evaluate the tentative path segment's feasibility using the computer model; and cause the output device to provide feedback indicating an outcome of the evaluation.

The second aspect generally shares the effects of the first aspect of the invention, and it can be implemented with a corresponding degree of technical variation.

The invention further relates to a computer program containing instructions for causing a computer, or the teach interface in particular, to carry out the above method. The computer program may be stored or distributed on a data carrier. As used herein, a “data carrier” may be a transitory data carrier, such as modulated electromagnetic or optical waves, or a non-transitory data carrier. Non-transitory data carriers include volatile and non-volatile memories, such as permanent and non-permanent storage media of magnetic, optical or solid-state type. Still within the scope of “data carrier”, such memories may be fixedly mounted or portable.

### BRIEF DESCRIPTION OF THE DRAWINGS

Aspects and embodiments are now described, by way of example, with reference to the accompanying drawings, on which:

FIG. 1 shows a painting robot operating in a workspace under the control of a robot controller executing a robot program C;

FIG. 2 shows a teach interface with a handheld input device, for generating a robot program, according to an embodiment of the invention; and

FIG. 3 is a flowchart of a method for generating a robot program, according to an embodiment of the invention.

### DETAILED DESCRIPTION

The aspects of the present disclosure will now be described more fully hereinafter with reference to the accompanying drawings, on which certain embodiments of the invention are shown. These aspects may, however, be embodied in many different forms and should not be construed as limiting; rather, these embodiments are provided by way of example so that this disclosure will be thorough and complete, and to fully convey the scope of all aspects of the invention to those skilled in the art. Like numbers refer to like elements throughout the description.

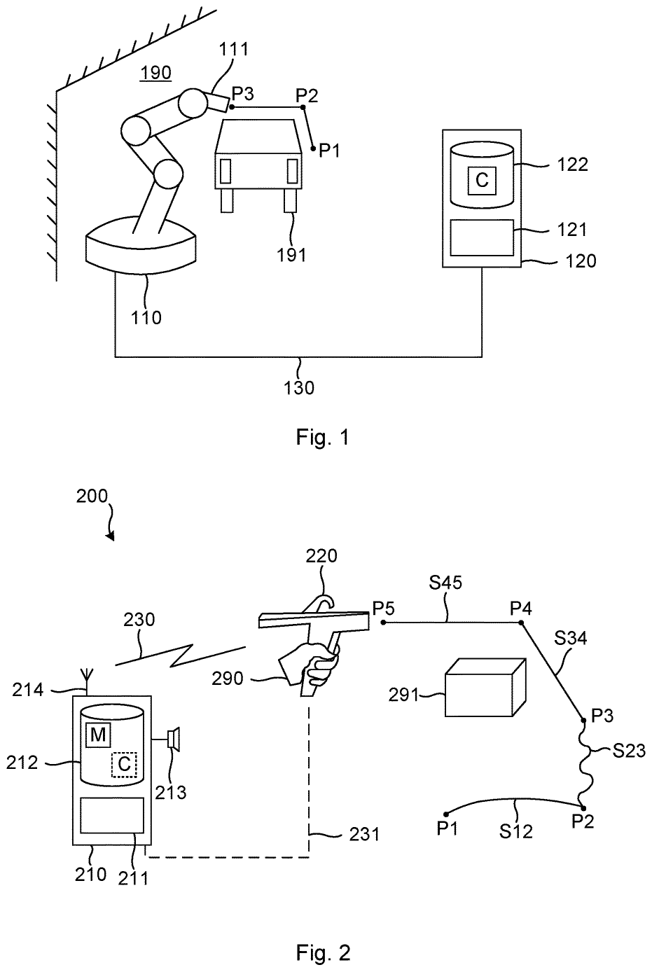

FIG. 1 shows an industrial robot, which includes a robot manipulator (or robot arm) 110 and robot controller 120 communicatively coupled to the robot manipulator 110 over a wired or wireless connection 130. The robot manipulator 110 is structured as an arm mounted on a base, wherein the arm has a plurality of linear or angular joints and is configured for carrying a tool (or end effector) 111. A past trajectory of the tool is indicated in FIG. 1, which includes control points P1, P2, P3 and straight connecting path segments extending between these. The robot controller 120 comprises processing circuitry 121 and a memory 122 suitable for storing, inter alia, executable programs C, system configurations files, log files descriptive of past operation of the robot and the like. Although, for simplicity of the drawing, a local implementation of the robot controller 120 is shown, distributed implementations relying on networked (or cloud) processing and storage resources also fall within the scope of the present disclosure. The connection 130 is preferably bidirectional, on the one hand adapted for conveying instructions from the controller 120 to actuators in the robot manipulator 110, and on the other hand for conveying signals from sensors in the robot manipulator 110 to the controller 120. The sensor-related signals may indicate not only external conditions prevailing in the environment of the robot manipulator 110 but also internal states of the robot manipulator 110, such as current joint positions and joint speeds, success/failure of the execution of a past instruction, and a charge, refill or maintenance status.

For purposes of illustration and not limitation, the robot manipulator 110 is shown as a painting robot carrying a printhead tool. The painting robot operates in a work cell 190 and is movable relative to a workpiece 191 (e.g., a car body), to which paint or another fluid is to be applied. The robot controller 120 may be responsible for controlling the action of the printhead, in addition to the control it exerts over the actuators in the robot manipulator 110. A viable alternative would be to provide a dedicated printhead controller, a separate entity adapted to operate in parallel with the robot controller 120 or under the supervision of the robot controller 120. As suggested in FIG. 1 at the left and upper sides of the work cell 190, the movements of the robot manipulator 110 may need to be physically confined to a closed or semi-closed region of space to avoid collisions. Similarly, the robot manipulator 110 may need to be scheduled for motion in such manner that it observes a safety margin to the workpiece 191 and any further obstacles present in the interior of the work cell 190.

FIG. 2 shows, in block-diagram form, a teach interface 200 suitable for generating a program C for controlling an industrial robot of the type depicted in FIG. 1. The teach interface 200 includes a processing unit 210 with processing circuitry 211 and a memory 212. The memory 212 stores a predefined computer model M of the robot manipulator 110, which will form the basis of a feasibility check of a tentative path segment to be described below. The form of the computer model M is not essential to the present invention; rather it may be formulated in a machine-readable language of the implementer's choice and structured as the implementer sees fit. Substantively, the model M may encode equations of motion, forward and backward kinematics equations, physical limits of the work cell 190, a physical extent of the workpiece 191 etc. The memory 212 may further store a program C which is being developed by means of the teach interface 200. The method 300 to be described below assists the operator in entering new control points in the program C by checking their feasibility against the computer model M. To output feedback informing the operator of an outcome of the feasibility evaluation, the processing unit 210 may further include an output device 213 for providing audible or visible signals.

The teach interface 200 in FIG. 2 further comprises an input device 220, which is suitable for being held by an operator's hand 290 and configured to communicate over a wireless link 230 with a wireless interface 214 of the processing unit 210. Alternatively, as suggested by the dashed connection line in FIG. 2, a wired communication link 231 may be used. In other embodiments, not illustrated here, the input device 220 is body-worn, i.e., it is integrated in a garment worn by the operator or is attached to a part of the operator's body in a manner not requiring him to grasp the input device 220 with the fingers.

The input device 220 has a motion tracking capability such that the processing unit can determine its position as often as necessary. Optionally, the motion tracking capability may as well be used to determine the orientation of the input device 220. The motion tracking may be visual, e.g., a camera observes the input device 220, which is optionally provided with visual markers, fiducials or the like but need not carry any active sensing component. Alternatively, the motion tracking of the input device 220 is nonvisual. For this purpose, the input device 220 may be equipped with an infrared sensor, an inertial measurement unit, an accelerometer, a magnetometer, or combinations of these. Thanks to the motion tracking functionality, the operator can use the input device 220 to indicate discrete control points P1, P2, P3, P4, P5 to be followed by the robot manipulator 110. This may be experienced as an intuitive and realistic programming approach, especially if the input device 220 is used in the intended work cell or in the presence of a representative workpiece 291.

At the time of filing the present disclosure, it was possible to source an input device 220 with these characteristics from commercial suppliers. For example, suitable products could be found in the VIVE™ series supplied by HTC Corporation, New Taipei, and in the SteamVR™ Tracking series supplied by Valve Corporation, Bellevue, Washington.

In some embodiments of the teach interface 200, the output device 213 is replaced or supplemented by a haptic feedback functionality in the input device 220. For example, the operator may receive a vibratory confirmation when a new control point is accepted into the program C, and he may see or hear an error signal from the output device 213 if a problem related to control point is detected.

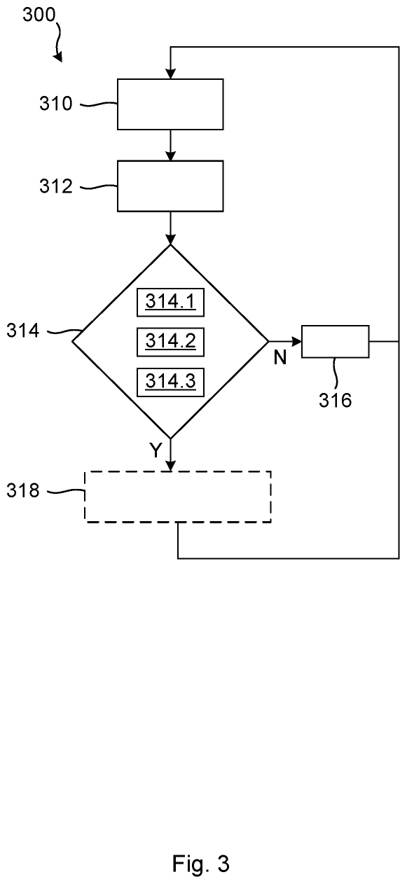

Turning to FIG. 3, there will now be described a method 300 of generating a program C for controlling an industrial robot. The method 300 may for example be executed by the processing unit 210 of the teach interface 200 illustrated in FIG. 2. The method 300 may as well be implemented by a programmable general-purpose computer with access to a computer model M of the robot manipulator 110 and so configured that the computer is operable to receive control-point information from a handheld or body-worn input device 200 and has at its disposal an output device 213 by which feedback to the operator can be provided.

In a first step 310 of the method 300, a tentative control point Pₙ to be executed by a robot manipulator 110 of the industrial robot is received. The term “control point” has been defined above. It is further recalled that the tentative control point Pa may optionally include a tool orientation of the robot manipulator 110. The orientation may correspond to the pose at which the input device 220 is being held when the tentative control point is entered.

In a second step 312, a tentative path segment S_{n-1,n} is generated, such that the path segment connects the tentative control point Pₙ with a preceding control point Pₙ₋₁. The preceding control point may be read from the program C under development or from a runtime memory. Accordingly, the preceding control point Pₙ₋₁ and the tentative control point Pₙ constitute the endpoints of the tentative path segment S_{n-1,n}, and they may be applied as boundary conditions in calculations within step 312. In some embodiments, step 312 includes generating the tentative path segment as a straight connection line between the preceding control point and the tentative control point. In some embodiments, step 312 may as well include optimizing the tentative path segment with respect to mechanical wear, energy consumption, speed etc., and certainly subject to the condition that the preceding control point Pₙ₋₁ and the tentative control point Pₙ shall be the endpoints of the tentative path segment. This is suggested graphically in FIG. 2, where segment S12 deviates from a straight connection line between control points P1 and P2, which may reflect a dynamically more lenient path. Further optional features of the segment generation 312 may be:
avoidance of known obstacles, possibly subject to a constraint on the maximal deviation from a straight line;
observance of a desired tool orientation defined by the tentative control point. This could rule out such joint-space realizations where the robot manipulator 110 does reach the desired point in space but is unable to turn the tool as desired; and
user-configured modulation of the path segment, as illustrated by the oscillatory lateral movement overlaid on segment S23 in FIG. 2.

In a third step 314 of the method 300, the tentative path segment's S_{n-1,n} feasibility is evaluated using the computer model M of the robot manipulator 110. The feasibility evaluation may include determining one or more joint-space realizations

$${T}_{n - 1 , n}^{( s )} ,$$

s=1, 2, . . . , of the tentative path segment, e.g., using backward kinematics. A realization

$${T}_{n - 1 , n}^{( s )}$$

can be thought or as a curve in many-dimensional joint space Q. The execution of these joint-space realization(s) may be simulated on a realistic time scale to evaluate forces and torques exerted between components of the robot manipulator 110 to ascertain whether these stay within acceptable limits.

In some embodiments, the feasibility evaluation may be a stateful process, which depends on a past trajectory of the robot manipulator, that is, the trajectory up to the preceding control point Pₙ₋₁. The dependence may be expressed as a patching criterion at the preceding control point. The patching criterion may require for the robot manipulator's 110 trajectory to be continuous past the preceding control point Pₙ₋₁, or for its first (or higher) derivative to be continuous past the preceding control point. The derivative may be taken with respect to time, path length or an arbitrary curve parameter. The continuity may be evaluated for each Cartesian component separately or with respect to a (Euclidean) norm of all components. A patching criterion of this nature may be enforced already in the step 312 of generating the tentative path segment S_{n-1,n}. Optionally, the patching criterion may require the joint-space realization

$${T}_{n - 1 , n}^{( s )}$$

to be continuous past the preceding control point Pₙ₋₁, or that its first (or higher) derivative be continuous past the preceding control point. The patching criterion may be applied as part of generating the joint-space realizations of the tentative path segment.

In some embodiments, the feasibility evaluation may include one or more of the following sub-evaluations: a collision evaluation 314.1, a singularity evaluation 314.2, a reachability evaluation 314.3. A positive evaluation outcome may correspond to at least one of the joint-space realizations

$${T}_{n - 1 , n}^{( s )}$$

of the tentative path segment S_{n-1,n} successfully passing all sub-evaluations in force.

The collision evaluation 314.1 may consider the physical limits of the work cell 190, as well as locations of a workpiece 191, 291 and of known obstacles in the interior of the work cell 190.

The singularity evaluation 314.2 may be designed to scrutinize whether the joint configuration of the robot manipulator 110 comes too close to a singularity in joint space. Theoretically, a singularity may be defined as a zero of the determinant of the robot manipulator's 110 Jacobian matrix J. For purposes of a numerical implementation, a practicable criterion of a joint-space realization

$${T}_{n - 1 , n}^{( s )}$$

of the tentative path segment failing the singularity evaluation 314.2 is that the realization contains at least one point q₀ such that the absolute value of this determinant falls below a threshold: |det J(q₀)|≤ϵ for some ϵ>0.

The reachability evaluation 314.3 may be based on the physical limits of the robot manipulator's 110 ability to extend. It may further include an evaluation of internal forces and torques, which may be amplified when the robot manipulator 110 is carrying a heavy tool or a load.

In a fourth step 316, feedback indicating an outcome of the feasibility evaluation is provided. Preferably, to ensure that the teach interface 200 is perceived as responsive and efficient to work with, the path generation 312 and feasibility evaluation 314 should be so fast that a few seconds at most elapse between steps 310 and 316.

In some embodiments, the feedback is provided explicitly, in the sense that a distinct signal is provided for a positive and a negative outcome. In other embodiments, the feedback is at least partially implicit. For example, if one signal (e.g., haptic vibration) indicates a positive outcome of the feasibility evaluation, then the absence of this signal-which the operator may learn to anticipate-indicates a negative outcome. As suggested by the conditional structure of the flowchart, FIG. 3 relates to an embodiment where implicit feedback is used. More precisely, feedback is provided 316 in response to a negative outcome of the feasibility evaluation 314 (N branch), and this may be followed by a second execution of the first step 310, in which a second tentative control point P1, P2, P3, P4, P5 entered through the input device 220 is received.

In some embodiments, differentiated feedback is provided 316, especially differentiated negative feedback. For example, the outcomes collision, singularity, non-reachability may be represented by different musical tunes to be played. Alternatively, they may represent to different colors of a flash of light, or different messages to be displayed on a screen. Further alternatively, the outcomes may be indicated by three different sequences of vibratory pulses in the input device 220, which are distinguishable by an operator grasping the input device 220.

In case of a positive outcome of the feasibility evaluation 314 (Y branch), the execution proceeds to a fifth step 318, in which the tentative control point P1, P2, P3, P4, P5 is incorporated into the program C. The method 300 may then be executed anew, from the first step 310, to evaluate a new tentative control point and potentially incorporate it into the program C. When the generating of the program C has been completed, the operator may transfer it from the teach interface 200 to a robot controller 120 for execution. The programming may end with an optional post-processing step where the overall smoothness of the programmed manipulator trajectory is reviewed and improved and/or where a feasibility check of the program C as a whole is run.

In further developments of the method 300, step 312 includes generating, for one tentative control point Pₙ, a plurality of r₀ tentative path segments

$${S}_{n - 1 , n}^{( r )} , 1 \leq r \leq {r}_{0} ,$$

where each tentative path segment extends between the tentative control point Pₙ and a preceding control point Pₙ₋₁. For each tentative path segment

$${S}_{n - 1 , n}^{( r )} ,$$

then, a number so (r)≥1 of joint-space realizations

$${T}_{n - 1 ,}^{( r ) , ( s )} , 1 \leq s \leq {s}_{0} ( r ) ,$$

can be determined in the evaluation step 314. Accordingly, the total number of joint-space realizations to be evaluated is

$$R = {\sum }_{r = 1}^{{r}_{0}} {s}_{0} ( r ) .$$

The outcome of step 314 will be positive as soon as one of these R realizations passes the feasibility evaluation.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims.

1. A method of generating a program for controlling an industrial robot, comprising:
receiving a tentative control point to be executed by a robot manipulator of the industrial robot, wherein the tentative control point is entered using a handheld or body-worn input device with a motion tracking capability;
generating a tentative path segment connecting the tentative control point with a preceding tentative control point;
evaluating the tentative path segment's feasibility using a predefined computer model of the robot manipulators wherein the feasibility evaluation includes at least two of: a collision evaluation, a singularity evaluation, a reachability evaluation; and
providing feedback indicating an outcome of the evaluation, wherein different feedback is provided for at least two outcomes chosen from: collision, singularity, non-reachability.

2. (canceled)

3. (canceled)

4. The method of claim 1, wherein multiple tentative path segments are generated for one tentative control point.

5. The method of claim 1, wherein the feasibility evaluation includes evaluating alternative joint-space realizations of one tentative path segment.

6. The method of claim 1, wherein the feasibility evaluation is implemented as a stateful process, which depends on a past trajectory of the robot manipulator.

7. The method of claim 1, further comprising, in case of a favorable outcome of the feasibility evaluation: incorporating the tentative control point into a program in the course of being generated.

8. The method of claim 1, wherein the feedback is tactile feedback provided through the input device.

9. The method of claim 1, wherein the feedback is audible feedback.

10. The method of claim 1, wherein the tentative control point further includes a tool orientation.

11. The method of claim 1, wherein the input device has a nonvisual motion tracking capability.

12. The method of claim 11, wherein the motion tracking capability is realized by one or more of: an infrared sensor, an inertial measurement unit, an accelerometer, a magnetometer.

13. A teach interface for generating a program for controlling an industrial robot, comprising:
a processing unit with access to a computer model of a manipulator of the industrial robot;
an input device suitable for being held or worn by an operator; and
an output device configured to provide feedback to the operator,
wherein the processing unit includes processing circuitry configured to:
receive from the input device a tentative control point to be executed by the manipulator of the industrial robot;
generate a tentative path segment connecting the tentative control point with a preceding control point;
evaluate the tentative path segment's feasibility using the computer model wherein the feasability evaluation includes at least two of: a collision evaluation, a singularity evaluation, a reachability evaluation; and
cause the output device to provide feedback indicating an outcome of the evaluation, wherein different feedback is to be provided for at least two outcomes chosen from: collision, singularity, non-reachability.

14. A computer program comprising instructions to cause a teach interface to generate a program for controlling an industrial robot, the teach interface having:
a processing unit with access to a computer model of a manipulator of the industrial robot;
an output device configured to provide feedback to the operator;
wherein the processing unit further comprises processing circuitry;
wherein the instructions, upon execution by the processing unit, causes the teach interface to:
receive a tentative control point to be executed by a robot manipulator of the industrial robot, wherein the tentative control point is entered using a handheld or body-worn input device with a motion track a capability;
generate a tentative path segment connecting the tentative control point with a preceding control point;
evaluate the tentative path segment's feasibility using a predefined computer model of the robot manipulator wherein the feasibility evaluation includes at least two of: a collision evaluation, a singularity evaluation, a reachability evaluation; and
provide feedback indicating an outcome of the evaluation, wherein different feedback is provided for at least two outcomes chosen from: collision, singularity, non-reachability.

15. The computer program of claim 14, further comprising a data carrier.
